(19) United States
(12) Patent Application Publication
(10) Pub. No.: US 2024/0346210 A1
(43) Pub. Date: Oct. 17, 2024

(54) MULTI-SCALE ANALYSIS METHOD FOR TIME SERIES BASED ON QUANTUM WALK

(71) Applicant: NANJING NORMAL UNIVERSITY, Jiangsu (CN)

(72) Inventors: Zhaoyuan YU, Jiangsu (CN); Lingling SUN, Jiangsu (CN); Binghuang PAN, Jiangsu (CN); Wen LUO, Jiangsu (CN); Linwang YUAN, Jiangsu (CN)

(73) Assignee: NANJING NORMAL UNIVERSITY, Jiangsu (CN)

(21) Appl. No.: 18/036,654

(22) PCT Filed: Dec. 31, 2021
(86) PCT No.: PCT/CN2021/143601

§ 371 Date: May 12, 2023

(30) Foreign Application Priority Data
Dec. 9, 2021 (CN) 202111499360.7

(51) Int. Cl. G06F 30/27; G06F 119/12

(52) U.S. Cl. CPC G06F 30/27; G06F 2119/12

(57) ABSTRACT

Disclosed in the present disclosure is a multi-scale analysis method for time series based on quantum walk, including (1). generating multi-scale and multi-feature sequences based on quantum walk; (2). screening feature sequences; (3). modeling and predicting time series based on regression analysis; (4). performing frequency domain and time domain-based result evaluation; and (5). performing experimental verification. The method of the present disclosure has the advantage that the multi-scale features of the quantum walk are applied to the analysis of time series, and by combining feature extraction methods under two rules, a model of an original time series is established based on extracted features by using linear, nonlinear and time-based regression methods. The analysis method for time series does not require pre-assumption such as stationarity assumption, and is a universal analysis method for time series.

### BACKGROUND

### Technical Field

The present disclosure relates to the field of data analysis and quantum computing, and particularly relates to a multi-scale analysis method for time series based on quantum walk.

### Description of Related Art

Time series analysis is a series of analysis methods implemented by extracting change characteristics of original data sequences by using statistical methods and then performing modeling and prediction. Time series are widely presented, and any index changes over time may be represented in the form of time series. Variation characteristics over time included in time series may be used to reveal development laws, change trends, and the like, and multi-time series associated with geographic locations also include spatially interacting features. Currently, there are a large number of time series decomposition and modeling models, which are mainly divided into parametric and non-parametric methods. Common time series analysis methods include an autoregressive (AR) model, a moving average (MA) model and a nonlinear time series model, and the like, and there are time series analysis methods from the perspectives of a time domain and a frequency domain. At present, the time series analysis methods are gradually being perfected. However, in most of the current time series analysis methods, certain assumptions usually need to be made when statistical inference is performed, such as an assumption of data stationarity, which determines that a statistical law of process features does not change with time; secondly, in some time series analysis methods, factors influencing the change of time series are found based on the time series decomposition, which belongs to an inverse inference; and in some cases, time series are modeled by using the combination fitting of random data, but traditional random data generation is data generation under specific rules, and thus generated data are not real random data, and a spatial correlation between time series cannot be considered when multiple time series are modeled.

With the development of quantum walk, random data simulation based on quantum rules is brought, and feature sequences generated based on the quantum rules have both temporal correlation and spatial coherence. Data analysis, data computation, and data simulation based on quantum laws belong to the frontiers of modern science. Quantum walk is one of the most typical and simplest quantum computing methods, and it constitutes a general model of quantum computing, and is one of a small number of quantum computing methods in which efficient simulation and solution can be performed by using a numerical calculation method.

### SUMMARY

The objective of the invention: in view of the above problems, the present disclosure provides a multi-scale analysis method for time series based on quantum walk, in which multi-feature sequences are generated based on quantum walk, specific feature combinations are screened out for different time series, and modeling analysis is performed on the time series from linear, nonlinear and time perspectives and the like, and then multi-scale time series structure features may be extracted. In addition, the evaluation of the correlation between the modeled and predicted result sequence and the original time series may also be performed from the perspectives of the frequency domain and time domain and the like.

Technical solution: to achieve the objective of the present disclosure, the technical solution adopted in the present disclosure is: a multi-scale analysis method for time series based on quantum walk, specifically includes the following steps:
Step 1. For an original observed time series, generating a plurality of feature sequences at different time scales based on quantum walk;
Step 2. Performing feature selection on the plurality of feature sequences at different time scales generated in step 1 to obtain an optimal feature sequence combination;
Step 3. Establishing a correlation model of the original observed time series and the optimal feature sequence combination based on a regression analysis method; and
Step 4. Predicting an actual observed time series by using the correlation model in step 3, and the prediction results are verified in the time domain and frequency domain.

Further, the method also includes:
Step 5. performing experimental verification on the multi-scale analysis method, where experimental configurations in the experimental verification are specifically as follows:
Experiment data configuration: satellites in a plurality of Pacific positions are selected, and absolute sea level data obtained by height measurement of the satellites is periodically collected, and then processed to obtain experimental data; and
Evaluation index configuration: a coefficient of determination R², a root-mean-square error (RMSE), and a mean absolute error (MAE) are selected as evaluation indexes of the prediction result of the model, where the evaluation indexes are specifically expressed as follows:

$${R}^{2} = 1 - \frac{{\sum }_{i = 1}^{N} {( {y}_{i} - {\hat{y}}_{i} )}^{2}}{{\sum }_{i = 1}^{N} {( {y}_{i} - \overline{y} )}^{2}} \\ RMSE = \sqrt{\frac{1}{N} {\sum }_{i = 1}^{N} {( {\hat{y}}_{i} - {y}_{i} )}^{2}} \\ MAE = \frac{1}{N} {\sum }_{i = 1}^{N} \vert {\hat{y}}_{i} - {y}_{i} \vert$$

where, yᵢ is an i-th element of the actual observed time series, ŷᵢ is an i-th element of a fitted sequence obtained by prediction, y̅ is an average value of elements of the actual observed time series, and N is the length of the time series.

Further, step 1 is specifically implemented as follows:
representing a quantum walk process by an arbitrary undirected graph G=(V, E), where V is a set of vertices, and E is a set of edges; the vertices represent quantum states in the quantum walk process, and the edges represent transitions of the quantum states between the vertices;
representing a quantum state vector at an initial moment in the quantum walk process by |φ(0) [symbol] , and representing. Based on the time evolution operator e^{-iHt}, a quantum state vector |φ(t) [symbol] at a moment t in the quantum walk process can be expressed as:

$$\vert φ ( t ) 〉 = {e}^{- ith} \vert φ ( 0 ) 〉$$

where, | [symbol] is a symbol for labeling state vectors, e^{-iHt} is the time evolution operator, i is an imaginary unit, and H is a Hamiltonian represented by an adjacency matrix or a Laplacian matrix;
decomposing a spectrum of the Hamiltonian H by using a spectrum decomposition algorithm to obtain eigenvalues and eigenvectors of the Hamiltonian H, where the decomposed Hamiltonian H is:

$$H = Φ {ΛΦ}^{T}$$

where, Φ is an N×N matrix, which represents a set of the eigenvectors; T represents a transposition; A is an N×N diagonal matrix, which is specifically expressed as Λ=diag(λ₁, λ₂, . . . , λₙ, . . . , λ_{N}), λ₁, λ₂, . . . , λ_{N} are the ordered eigenvalues of the Hamiltonian H; and N is the length of the time series;
the time evolution operator is expressed as e−^{iHt}=Φe−^{iΛt}Φ^{T}; and then
the quantum state vector |φ(t) [symbol] at the moment t in the quantum walk process is expressed as:

$$\vert φ ( t ) 〉 = Φ {e}^{- i Λ t} {Φ}^{T} \vert φ ( 0 ) 〉 ;$$

constructing a scale factor set {kⱼ}ⱼ₌₁^{J}, where J represents the total number of scale factors, and kⱼ represents a j-th scale factor; and when the moment t is replaced with kⱼn, the quantum state vector in the quantum walk process is expressed as:

$$\vert φ ( {k}_{j} n ) 〉 = Φ {e}^{- i Λ {k}_{j} n} {Φ}^{T} \vert φ ( 0 ) 〉 , {k}_{j} ∈ {ℝ}^{+}$$

where, [symbol] ⁺ represents a positive real number, n is a natural number, n=0, 1, 2, . . . ; and
sampling the quantum walk process at an equal time interval based on the scale factor kⱼ to obtain a sequence of norm squares of probability amplitudes corresponding to all the vertices, thereby generating the feature sequences of the quantum walk at different time scales.

Further, the Hamiltonian I is represented by an adjacency matrix of graph G, and elements in the adjacency matrix of the graph G are expressed as:

$${A}_{uv} = \{ \begin{matrix}1 , & if ( u , v ) ∈ E \\ 0 , & otherwise\end{matrix}$$

where, (u, v) represents an edge connecting a vertex u to a vertex v. Aᵤᵥ represents an edge between the vertex u and the vertex v, u∈V, v∈V, and Aᵤᵥ=Aᵥᵤ, and Aᵥᵥ=Aᵤᵤ=0.

Further, in step 2. feature selection is performed on the generated plurality of feature sequences at different time scales by using stepwise regression, which is implemented as follows:
combining the feature sequences at different time scales, constantly adjusting the combinations, evaluating the fitting accuracy in using the combinations to model the original observed time series by using the Akaike Information Criterion (AIC), and selecting a combination with the best evaluation result as the optimal feature sequence combination;
alternatively.
feature selection is performed on the generated plurality of feature sequences at different time scales by using the RReliefF algorithm, which is implemented as follows:
performing weight computation on the plurality of feature sequences at different time scales in step 1 based on the original observed time series, performing sorting according to the weights from large to small, and combining the first Q feature sequences at different time scales to form the optimal feature sequence combination.

Further, the regression analysis method in step 3 includes linear regression, nonlinear regression, or time-correlation-based vector autoregression methods, where the linear regression includes but is not limited to stepwise regression, principal component regression, and partial least squares regression; and the nonlinear regression includes but is not limited to projection pursuit regression.

Further, in step 3, a correlation model of the original observed time series and the optimal feature sequence combination is established based on the linear regression, which is specified as follows:

$$Y = {β}_{1} {X}_{1} + {β}_{2} {X}_{2} + … + {β}_{q} {X}_{q} + ε$$

where, Y is a fitted time series, X₁, X₂, . . . , X_{q} are sequences in the optimal feature sequence combination respectively, β₁, β₂ . . . , β_{q} are coefficients of the sequences respectively, and ε is a constant term.

Further, in step 3, a correlation model of the original observed time series and the optimal feature sequence combination is established based on the projection pursuit regression, which is specified as follows:

$$F ( x ) \sim {\sum }_{m = 1}^{M} {β}_{m} {G}_{m} ( {Z}_{m} ) = {\sum }_{m = 1}^{M} {β}_{m} {G}_{m} ( {\sum }_{p = 1}^{P} {a}_{mp}^{T} X )$$

where, F(x) represents a fitted time series, Gₘ(Zₘ) represents a m-th ridge function. βₘ is a weight and represents the contribution of the m-th ridge function to an output value. M represents the total number of the ridge functions,

$${Z}_{m} = {\sum }_{p = 1}^{P} {a}_{mp}^{T} X$$

is an independent variable of the m-th ridge function and represents a projection of a P-dimensional vector X in an αₘ direction, X represents high-dimensional data input in the model. αₘₚ is a p-th component of the projection in the αₘ direction, a superscript T represents a transposition. P is a dimension of input space,

$${\sum }_{p = 1}^{P} {a}_{r}^{2} = 1$$

is required, and αₚ represents a p-th component in a projection direction.

Further, in step 3, a correlation model of the original observed time series and the optimal feature sequence combination is established based on the time-correlation-based vector autoregression, and the sequences in the optimal feature sequence combination are expressed in the form of a matrix as, Y={X₁, X₂, . . . , X_{w}, . . . X_{L}}∈ [symbol] ^{N×L}, which is specified as follows:

$$\begin{matrix}{X}_{w} = {( {X}_{1 w} , {X}_{2 w} , … , {X}_{Nw} )}^{T} ∈ {ℝ}^{N \times 1} \\ {X}_{w} = {\sum }_{z = 1}^{d} {A}_{z} {X}_{w - z} + {ε}_{w} , w = d + 1 , … , L\end{matrix}$$

where, N represents the length of the time series. L represents the number of the sequences in the optimal feature sequence combination. X_{w} represents vectors in a w-th column of a matrix Y. X_{w-z} represents vectors in a w-z-th column of the matrix Y. X_{Nw} represents an element value in the N-th row and the w-th column of the matrix Y, A₂∈ [symbol] ^{N×N} is a coefficient matrix of the time-correlation-based vector autoregression, z is a lag order, d is a total lag order, and εw represents noise.

Further, in step 4, time-frequency domain-based result evaluation is performed on a prediction result, which is implemented specifically as follows:
selecting a coefficient of determination R², a root-mean-square error (RMSE) and a mean absolute error (MAE) as evaluation indexes of the prediction result of the model, where the evaluation indexes are expressed as follows:

$$\begin{matrix}{R}^{2} = 1 - \frac{{\sum }_{i = 1}^{N} {( {y}_{i} - {\hat{y}}_{i} )}^{2}}{{\sum }_{i = 1}^{N} {( {\hat{y}}_{i} - \overline{y} )}^{2}} \\ RMSE = \sqrt{\frac{1}{N} {\sum }_{i = 1}^{N} {( {\hat{y}}_{i} - {y}_{i} )}^{2}} \\ MAE = \frac{1}{N} {\sum }_{i = 1}^{N} \vert {\hat{y}}_{i} - {y}_{i} \vert\end{matrix}$$

where, yᵢ is an i-th element of the actual observed time series, ŷᵢ is an i-th element of a fitted sequence obtained by prediction, y̅ is an average value of elements of the actual observed time series, and N is the length of the time series.

Beneficial effects: Compared with the prior art, the technical solution of the present disclosure has the following beneficial technical effects:

the present disclosure provides a general multi-scale analysis method for time series based on quantum walk, and constructs an analysis method including quantum walk-based multi-feature sequence generation, feature sequence selection, data modeling and prediction, and model evaluation. A sequence combination with spatial-temporal features is generated on the premise that no pre-assumption is made, a feature sequence combination is extracted according to the analysis requirements of different time series, time series model based on different perspectives is established by using feature connections between actual time series and the feature sequence combination from different perspectives, and prediction is performed based on the model. The method provided by the present disclosure does not belong to an inverse inference. The feature sequences proposed in the present disclosure are generated based on a general rule of quantum walk, and a specific time series is expressed by some features generated by quantum walk. According to the method provided by the present disclosure, the change characteristics of the quantum walk in space and time are represented in the manner of feature sequences, and these features are used in data analysis, which is a major breakthrough in the application of quantum walk in the field of data analysis.

### BRIEF DESCRIPTION OF THE DRAWINGS

FIG. 1 is a flowchart of a multi-scale analysis method for time series based on quantum walk according to the present disclosure in an embodiment;

FIG. 2 is a data processing flowchart of a multi-scale analysis method for time series based on quantum walk according to the present disclosure in an embodiment;

FIG. 3 is a graph showing the sea level height changes of research points in an embodiment;

FIG. 4 is a graph showing the first four groups of quantum walk feature sequences in an embodiment;

FIG. 5 is a graph showing the results of linear regression and prediction performed based on stepwise regression screening results in an embodiment;

FIG. 6 is a graph showing the results of linear regression and prediction performed based on RreliefF algorithm screening results in an embodiment;

FIG. 7 is a graph showing the results of PPR regression and prediction performed based on stepwise regression and RReliefF screening results in an embodiment;

FIG. 8 is a graph showing the results of PPR regression and prediction performed based on stepwise regression and RReliefF screening results in an embodiment;

FIG. 9 is a power spectrum density diagram of the results of modeling and prediction performed based on stepwise regression screening results in an embodiment;

FIG. 10 is a power spectrum density diagram of the results of modeling and prediction performed based on RReliefF screening results in an embodiment;

FIG. 11 is a graph showing a statistical comparison result of different regression methods in an embodiment; and

FIG. 12 is a graph showing a statistical comparison result of different regression and prediction methods in an embodiment.

### DESCRIPTION OF THE EMBODIMENTS

The technical solutions of the present disclosure will be further described below with reference to the accompanying drawings and embodiments.

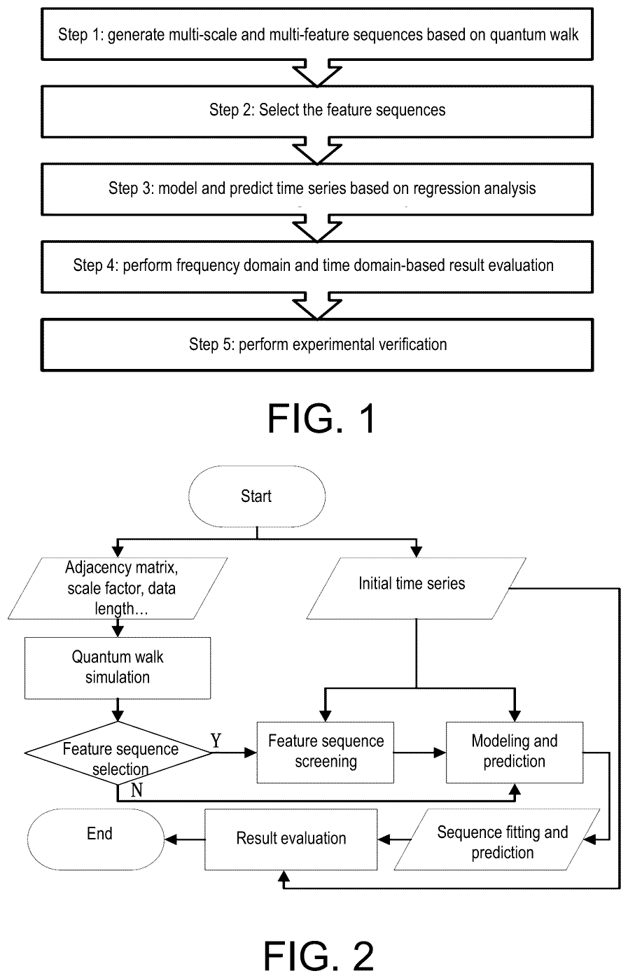

Referring to FIG. 1, a multi-scale analysis method for time series based on quantum walk according to the present disclosure specifically includes the following steps:
step 1: generation of multi-scale and multi-feature sequences based on quantum walk;

Actual time series often have spatial locations, and the evolutions of the time series will affect each other. By using the quantum walk method, matching feature sequences may be generated according to the different spatial relations. Before the feature sequences are generated by using quantum walk, a spatial location relation between time series needs to be determined and abstracted in the form of a graph.

Quantum walk is generally regarded as a general-purpose computing tool, and all quantum computations can be performed on graphs in a quantum walk manner. A graph on which the quantum walk is performed consists of vertices and edges, and can be expressed in the form of an adjacency matrix. The vertices of the graph represent corresponding quantum states at the vertices when a quantum walker walks, and the edges connecting the vertices carry the transitions of the quantum states between the vertices. For the datamation of the features of the quantum walk, the time-varying probability of the walker at each vertex is collected to form a feature sequence. In the quantum walk process, the time-varying probability of the quantum walker at each vertex reflects the change characteristics of a wave function. Through an algorithm of spectrum decomposition, the quantum walk process is computed and simulated based on the graph-based adjacency matrix.

The quantum walk process is described using an arbitrary undirected graph. G=(V, E) is set to be an undirected unweighted graph, where V is a set of N vertices, and E is a set of edges. For any vertex v, (u, v) represents an edge connecting a vertex u to a vertex v. An adjacency matrix A of the graph G may be defined as:

$${A}_{uv} = \{ \begin{matrix}1 , & if ( u , v ) ∈ E \\ 0 , & otherwise\end{matrix} \qquad ( 1 )$$

where Aᵤᵥ represents an edge between the vertex u and the vertex v, u∈V, v∈V, and Aᵤᵥ=Aᵥᵤ, and Aᵥᵥ=Aᵤᵤ=0.

Unlike a classical random walk, the quantum walk process is not a Markov chain. In general, the evolution of a state vector |φ(t) [symbol] over time t may be described in the form of the Schrödinger equation:

$$i \frac{d}{dt} \vert φ ( t ) 〉 = H \vert φ ( t ) 〉 \qquad ( 2 )$$

where, φ(t) represents the quantum state vectors corresponding to all vertices at a moment t in the quantum walk process. | [symbol] is a symbol for labeling state vectors. Hamiltonian H is an N×N Hermitian matrix, which can be replaced by an adjacency matrix or a Laplace matrix. For simplicity, in the present disclosure, the Hamiltonian H is replaced with the adjacency matrix A of graph G. |φ(t) [symbol] ∈ [symbol] ^{N} is a state vector of which one element is a complex number.

The evolution equation may be solved from Formula (2) through an initial state |φ(0) [symbol] , and the state vector |φ(t) [symbol] at the moment t may be expressed as:

$$\vert φ ( t ) 〉 = {e}^{- iHt} \vert φ ( 0 ) 〉 \qquad ( 3 )$$

where, e^{-iHt} is a time evolution operator, and is used to construct a dynamically evolving quantum walk; i is an imaginary unit; and H is the Hamiltonian. The state vector |φ(t) [symbol] of the quantum walk at the moment t is a linear combination of ground states. The probability that the quantum walker is found at each vertex is a norm square of a corresponding probability magnitude at each vertex in the state vector.

In order to obtain the state vector |φ(t) [symbol] , it is necessary to compute the time evolution operator e^{-iHt} with a matrix and a complex number. The spectrum of the Hamiltonian is decomposed into:

$$H = {ΦΛΦ}^{T} \qquad ( 4 )$$

where, Φ is an N×N matrix, representing a set of eigenvectors, and T represents a matrix transposition. Λ may be expressed as:

$$Λ = diag ( {λ}_{1} , {λ}_{2} , … , {λ}_{n} , … , {λ}_{N} ) \qquad ( 5 )$$

which is an N×N diagonal matrix, where λ₁, λ₂, . . . , λ_{N} are ordered eigenvalues of H. By using the spectrum decomposition of the Hamiltonian H, the time evolution operator may be expressed as:

$${e}^{- iHt} = {Φe}^{- i Λt} {Φ}^{T} \qquad ( 6 )$$

Formula (3) can be expressed as:

$$\vert φ ( t ) 〉 = {Φe}^{- i Λt} {Φ}^{T} \vert φ ( 0 ) 〉 \qquad ( 7 )$$

QR decomposition is used to compute the eigenvalues and eigenvectors of Hamiltonian H. The evolution of the state vector is simulated using the eigenvalues, the eigenvectors, and the time t, which is implemented by Formula (7).

The probability that the quantum walker is found at each vertex can be expressed by computing a norm square of a corresponding probability amplitude at each vertex in the eigenvector. To obtain the change characteristics of the quantum walk at different time scales, a scale factor is set, the quantum walk is sampled at an equal time interval based on the scale factor, and then a probability sequence corresponding to all the vertices is obtained, which represents the change characteristic of the quantum walk at one time scale. To obtain a set of feature sequences for data modeling and prediction, the quantum walk is sampled multiple times using a plurality of different scale factors. For ease of understanding, a scale factor set {kⱼ}ⱼ₌₁^{J} is defined, where J represents the number of the scale factors. The time t may be replaced with kⱼn, n in kⱼn is represented by a set of natural numbers, n=0, 1, 2, . . . , kⱼ∈ [symbol] ⁺, and [symbol] ⁺ represents a positive real number. Therefore, Formula (7) may be expressed as:

$$\vert φ ( k , n ) 〉 = {Φe}^{- i Λ k , n} {Φ}^{T} \vert φ ( 0 ) 〉 \qquad ( 8 )$$

Step 2: feature selection:

Based on step 1, suitable feature sequences can be generated by adjusting a parameter kⱼ, and a relation between an original observed time series and the generated feature sequences is established by using a regression method, to model the original time series. In order to obtain more features as much as possible, the scale factors are added to simulate as many sequences as possible. However, not all of the generated features are correlated with the original sequence, and overfitting will be caused when too many modalities are used to model the original time series. Therefore, in all generated modalities, a modality that may be used to represent the feature of the original time series is selected.

The present disclosure proposes the use of two feature selection methods, i.e., model-driven stepwise regression and data-driven RReliefF, respectively, where the stepwise regression may also be used for modeling and prediction. Here, the stepwise regression belongs to a regression method of linear modeling, which is implemented by constantly changing feature sequence combinations, evaluating the fitting accuracy in using these feature sequence combinations to model the original observed time series by using criteria such as the Akaike Information Criterion (AIC) and the like, determining whether the latest changed feature combination is reserved, reserving the latest changed feature combination if the fitting accuracy is better, otherwise, reserving the original feature combination. The RReliefF algorithm is implemented by computing a k nearest neighbor of each modality sample according to the original time series, computing relative weight values of all the modalities relative to an original time series sample, sorting all the modalities according to the weight values, and allowing to select the modalities with higher weights in sequence. For each modality, all possible k-nearest examples are tested, and the highest value is returned. By the RReliefF algorithm, all the quantum walk feature sequences can be subjected to weight computation based on the observed time series, and the number of required feature sequences can be selected according to the weights.
Step 3: modeling and prediction of time series based on regression analysis:

The present disclosure puts forward that a correlation between an actual time series and a screened feature sequence is sought from multiple perspectives, by use of three types of modeling methods including linear regression, nonlinear regression, and time-correlation-based regression, a correlation model between time series and quantum walk feature sequences is established, and the prediction of the original time series is realized through the combination of the quantum walk feature sequences based on the model. Where, the linear regression includes stepwise regression, principal component regression (PCR) and partial least squares regression (PLSR), and the like, and the nonlinear regression includes projection pursuit regression (PPR) and time-correlation-based vector autoregression (VAR) and the like.

According to the linear regression method, in the regression analysis of feature sequences generated based on quantum walk, based on different linear regression rules, an original time series is represented by a linear combination of the feature sequences generated based on quantum walk. The focus of linear regression is to determine the parameters of each feature sequence, so that these feature sequences can represent all the change characteristics of the original time series as much as possible.

$$Y = {β}_{1} {X}_{1} + {β}_{2} {X}_{2} + … + {β}_{q} {X}_{q} + ε \qquad ( 9 )$$

where, Y is a fitted time series, X₁, X₂, . . . , X_{q} are multi-scale feature sequences generated based on the quantum walk. β₁, β₂ . . . , β_{q} are coefficients of the sequences respectively, and ε is a constant term. In the three linear regression methods, an original time series is basically expressed by a linear combination of modalities, but in the different linear regression methods, specific algorithms are used to determine the coefficients.

The projection pursuit regression is a nonlinear regression analysis method for high-dimensional data, and is widely applied to prediction. The basic idea of PPR is to project high-dimensional data to a low-dimensional space (1-3 dimensional), find a projection that can reflect the structure or feature of the high-dimensional data, and perform regression analysis. The key to PPR is to determine a projection direction.

A projection pursuit regression analysis model may be expressed as:

$$F ( x ) - {\sum }_{{m = 1}^{}}^{M} {β}_{m} {G}_{m} ( {Z}_{m} ) = {\sum }_{{m = 1}^{}}^{M} {β}_{m} {G}_{m} ( {\sum }_{{p = 1}^{}}^{P} {a}_{mp}^{T} X ) \qquad ( 10 )$$

where, Gₘ(Zₘ) represents a m-th ridge function. βₘ is a weight value and represents the contribution of the m-th ridge function to an output value,

$${Z}_{m} = {\sum }_{{p = 1}^{}}^{P} {a}_{mp}^{T} X$$

is an independent variable of the ridge function and represents a projection of a P-dimensional vector X in an αₘ direction. αₘₚ is a p-th component in a m-th projection direction, P is a dimension of input space. T represents a transposition, and

$${\sum }_{{p = 1}^{}}^{P} {a}_{p}^{2} = 1$$

is required.

The time-correlation-based vector autoregression (VAR) is commonly used to predict a time series system with intrinsic relevant factors and analyze a dynamic impact of a stochastic disturbance on a variable system. According to the VAR method, a model is constructed by taking each intrinsic variable in the system as a function of all intrinsic variable lag values in the system, and thus, the method is commonly used for sequence correlation analysis. For a multi-time series Y={X₁, X₂, . . . X_{L}}∈ [symbol] ^{N×L}, the multi-time series is interpreted as a matrix, which represents that there are L groups of time series with the length of N. At any time w, a VAR (z) model may be represented as Formula (12):

$${X}_{w} = {( {X}_{1 w} , {X}_{2 w} , … , {X}_{Nw} )}^{T} ∈ {ℝ}^{N \times 1} \qquad ( 11 )$$

$${X}_{w} = {\sum }_{z = 1}^{d} {A}_{z} {X}_{w - z} + {ε}_{w} , w = d + 1 , … , L \qquad ( 12 )$$

where, A_{z}∈ [symbol] ^{N×N} is a coefficient matrix of VAR, ε_{w} is noise, and z is a lag order.
Step 4: frequency domain and time domain-based result evaluation

Time series includes structural features in the frequency domain and data features in the time domain. According to the present disclosure, power spectrum analysis is used in evaluating the features in the frequency domain of the time series, and a time-related sequence can be converted into a frequency-varying signal intensity distribution by computing a power spectrum density, so that the degree of fitting between the sequences in the frequency domain can be reflected. A correlation between the results of modeling and prediction and the original time series in terms of time features is evaluated. According to the present disclosure, a data relation between two time series is represented by the coefficient of determinations (R²), root mean square errors (RMSE), and average absolute errors (MAE) of the two time series.

$${R}^{2} = 1 - \frac{{\sum }_{i = 1}^{N} {( {y}_{i} - {\hat{y}}_{i} )}^{2}}{{\sum }_{i = 1}^{N} {( {y}_{i} - \overline{y} )}^{2}} \qquad ( 13 )$$

$$RMSE = \sqrt{\frac{1}{N} {\sum }_{i = 1}^{N} {( {\hat{y}}_{i} - {y}_{i} )}^{2}} \qquad ( 14 )$$

$$MAE = \frac{1}{N} {\sum }_{i = 1}^{N} \vert {\hat{y}}_{i} - {y}_{i} \vert \qquad ( 15 )$$

where, yᵢ is an i-th element of the original time series, ŷᵢ is an i-th element of a fitted sequence, y̅ is an average value of samples, and N is the length of the time series.
Step 5: experimental verification

Experimental configurations of the present disclosure mainly include the following parts: (1) experimental data configuration: absolute sea level data obtained by height measurement of satellites in seven Pacific positions is selected as experimental data (the data collection period is every week) in the present disclosure; and (2) evaluation index configuration: MAE, RMSE and R² are selected as model evaluation indexes in the present disclosure.

Based on the above experimental configurations, the results of the present disclosure are divided into the following two parts: (1) results of a plurality of modeling methods and prediction of height measurement data of the satellites based on quantum walk feature sequences; and (2) accuracy evaluation on the results of modeling and prediction based on two perspectives.

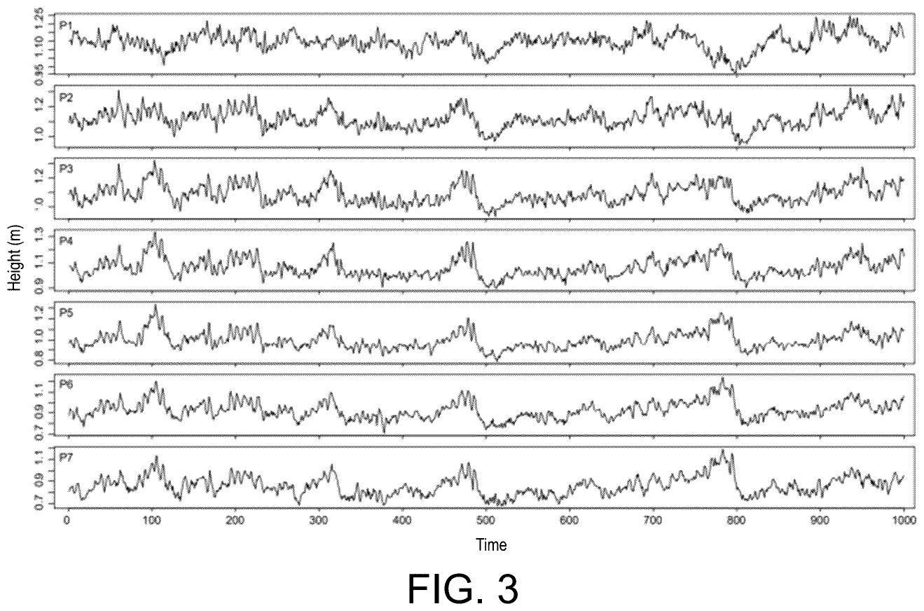

With the height measurement data of the satellites as an example, absolute sea level data, starting from Nov. 1, 2000, of seven positions are found, and recorded every week. The coordinates of the seven positions are respectively P1 (160.125° E, 0.125° N), P2 (170.125° E, 0.125° N), P3 (180.125° E. 0.125° N), P4 (190.125° E. 0.125° N), P5 (200.125° E. 0.125° N), P6 (210.125° E. 0.125° N), and P7 (220.125° E, 0.125° N), and the data is shown in FIG. 3. 1000 pieces of data are used in total, where the first 800 pieces of data are training samples, and the last 200 pieces of data are test samples. Multi-scale and multi-feature distribution data related to the seven positions are generated by using quantum walk, a feature combination similar to height measurement data features of the satellites is obtained by using two feature selection methods, then a relation between the height measurement data of the satellites and the features is obtained using a plurality of regression methods, a model is established, and 200 pieces of data after the training samples are predicted. The accuracy of model fitting and the accuracy of prediction are respectively evaluated.

Referring to FIG. 2, a data processing process includes:
1. Generation of multi-scale and multi-feature sequences based on quantum walk:
the quantum walk can simulate time-varying feature sequences with structural features, where an adjacency matrix needs to be input when a quantum walk simulation is performed, and the seven positions selected in this embodiment are located at the same latitude, and an adjacency matrix for generating quantum walk feature sequences is set as:

$$edges = [ \begin{matrix}0 & 1 & 0 & 0 & 0 & 0 & 0 \\ 1 & 0 & 1 & 0 & 0 & 0 & 0 \\ 0 & 1 & 0 & 1 & 0 & 0 & 0 \\ 0 & 0 & 1 & 0 & 1 & 0 & 0 \\ 0 & 0 & 0 & 1 & 0 & 1 & 0 \\ 0 & 0 & 0 & 0 & 1 & 0 & 1 \\ 0 & 0 & 0 & 0 & 0 & 1 & 0\end{matrix} ] \qquad ( 16 )$$

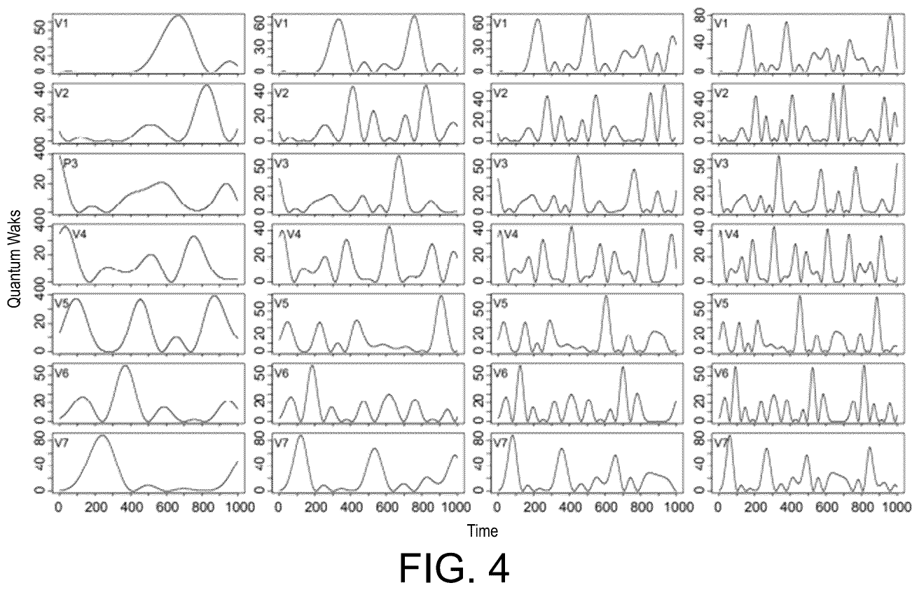

P1 is set to an initial position of a quantum walker. Since there are 1000 pieces of original data used in total, the length of data obtained at each time scale is set to 1000. To generate all possible situations of quantum dot distribution as far as possible, 2000 scale factors will be set for sampling in this embodiment, the minimum scale factor is 0.01 and increased by 0.01 sequentially. Quantum walk feature sequences generated by the first four scale factors are graphed, as shown in FIG. 4.
2. Feature selection:

Feature sequence combinations generated by the quantum walk are screened by using the screening methods of quantum stepwise regression and RReliefF respectively to obtain a modality combination similar to features of an original time series. Since the stepwise regression is a model-driven screening method, an optimal modality combination may be obtained by this algorithm; RReliefF is a data-based weight computation method, by which the weight of each modality with respect to the original time series can be computed, and a modality is selected based on the size of the weights. In this step, the number of feature sequences screened by use of stepwise regression is uncertain, and 100 feature sequences are screened for each research point based on the RReliefF.
3. Modeling and prediction of time series based on regression analysis:

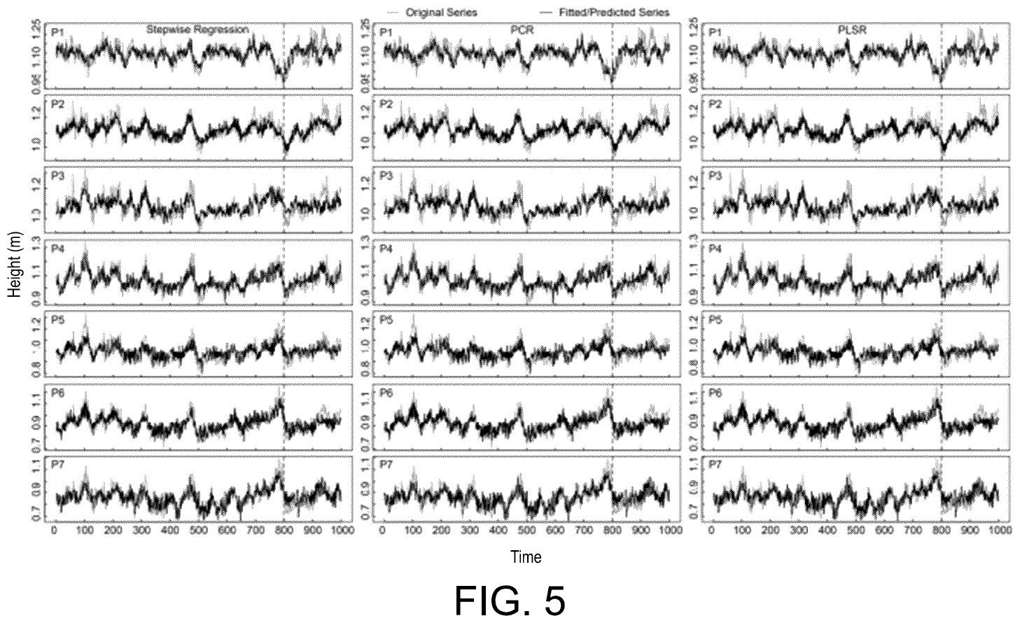

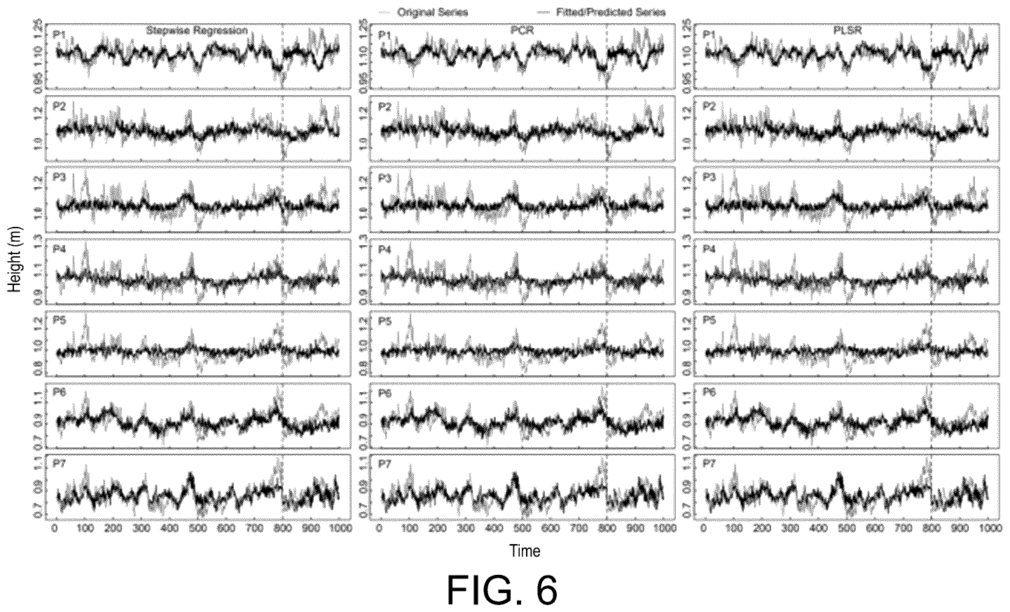

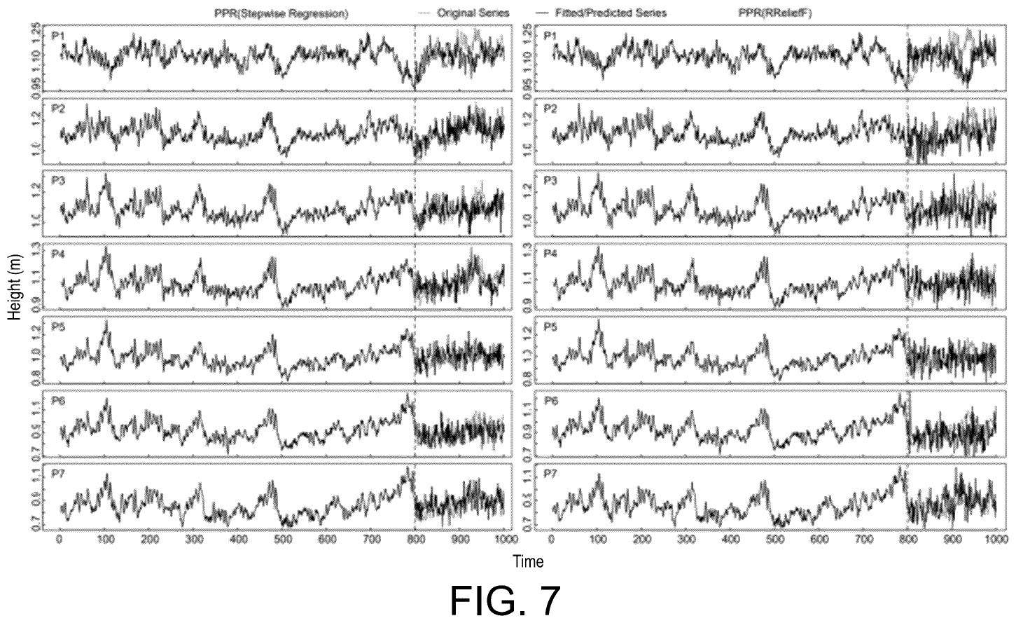

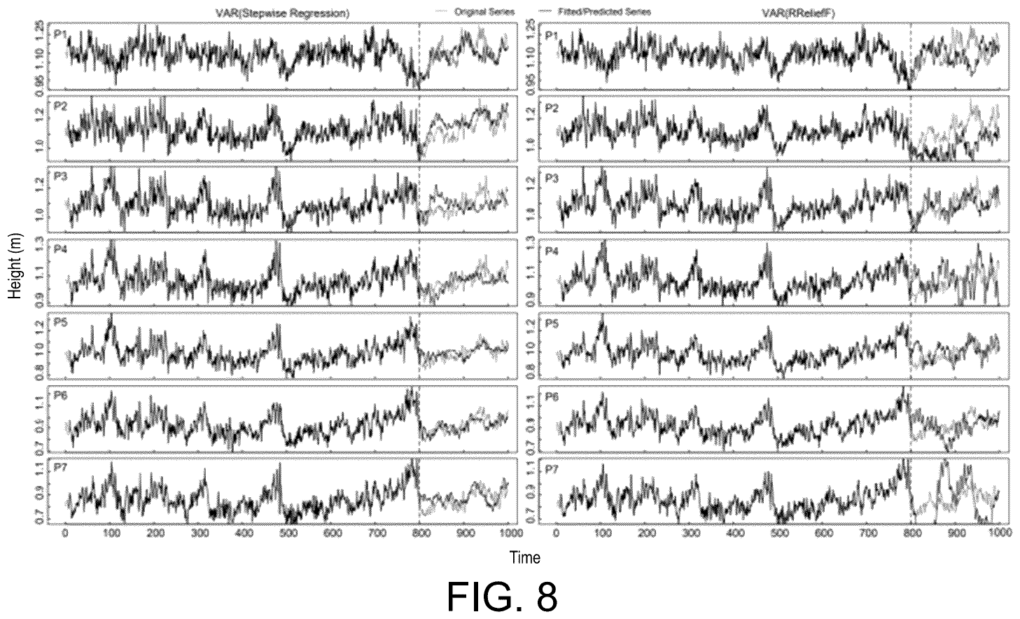

Based on feature selection results, an original time series is modeled and predicted by using five regression algorithms, i.e., stepwise regression, principal component regression, partial least squares regression, projection pursuit regression, and vector autoregression in the present disclosure, and 1000 sets of data are divided into 800 training samples and 200 test samples. The modeling and prediction of the three kinds are performed respectively based on stepwise regression and RReliefF screening results. FIG. 5 and FIG. 6 respectively show fitting results of modeling performed by using modality screening results of stepwise regression and RReliefF and results of prediction based on the established model. FIG. 7 is a graph showing the results of modeling and prediction performed based on projection pursuit regression. FIG. 8 is a graph showing the results of modeling and prediction performed based on vector autoregression.
4. Frequency domain and time domain-based result evaluation

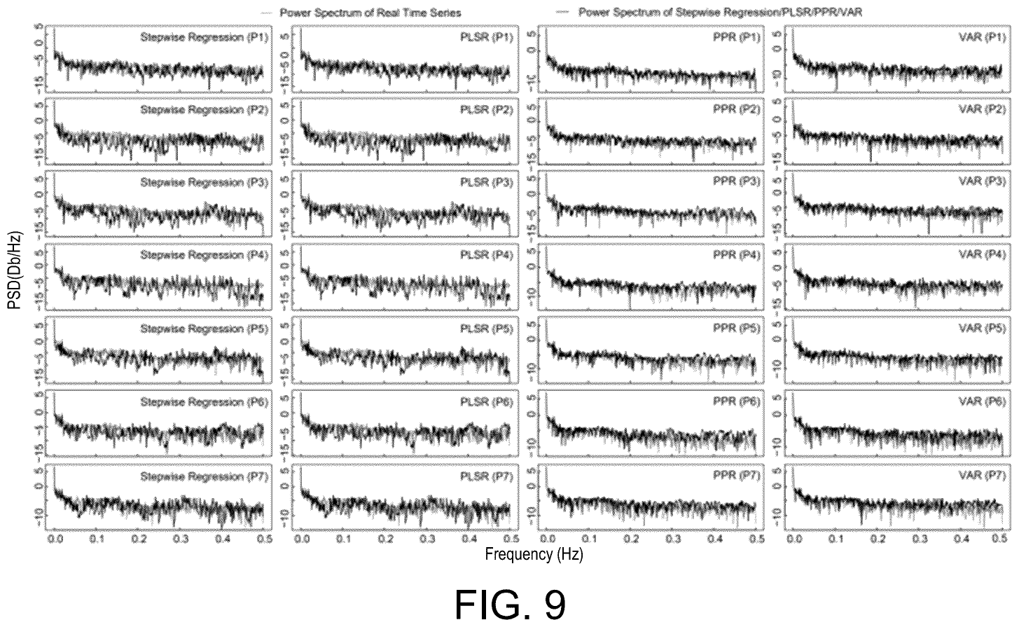

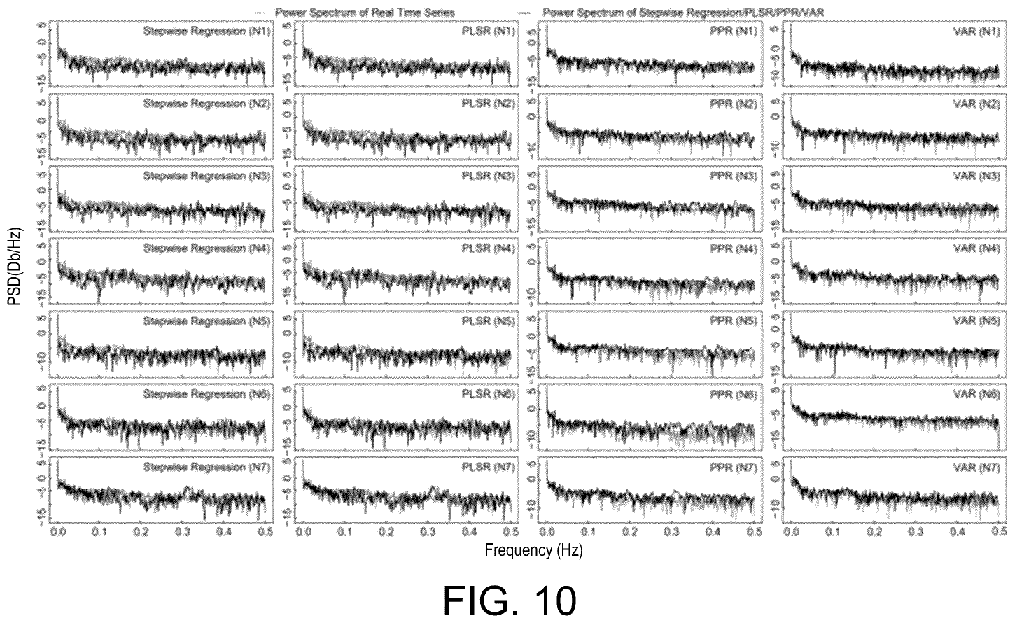

Based on Step 3, a correlation between sequences is analyzed from two aspects of frequency domain and time domain features in the present disclosure, a power spectrum structure of sea level data, fitting data, and predicted data is analyzed in terms of the frequency domain, and correlation indexes reflecting time domain features such as coefficient of determination and error and the like between two sequences are obtained in terms of the time domain. FIG. 9 and FIG. 10 are comparisons of power spectrum structures of results of modeling and prediction performed based on stepwise regression and RReliefF screening results respectively, and it can be seen intuitively from the figures that all experimental results are extremely similar to a spectrum structure of the initial time series, especially the projection pursuit regression and the time-correlation-based vector autoregression of the nonlinear regression.

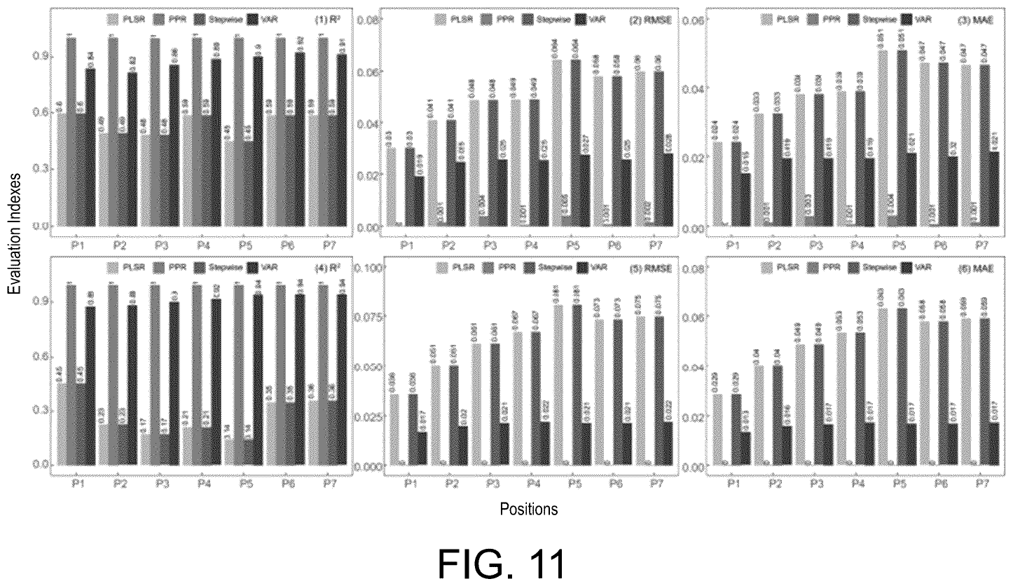

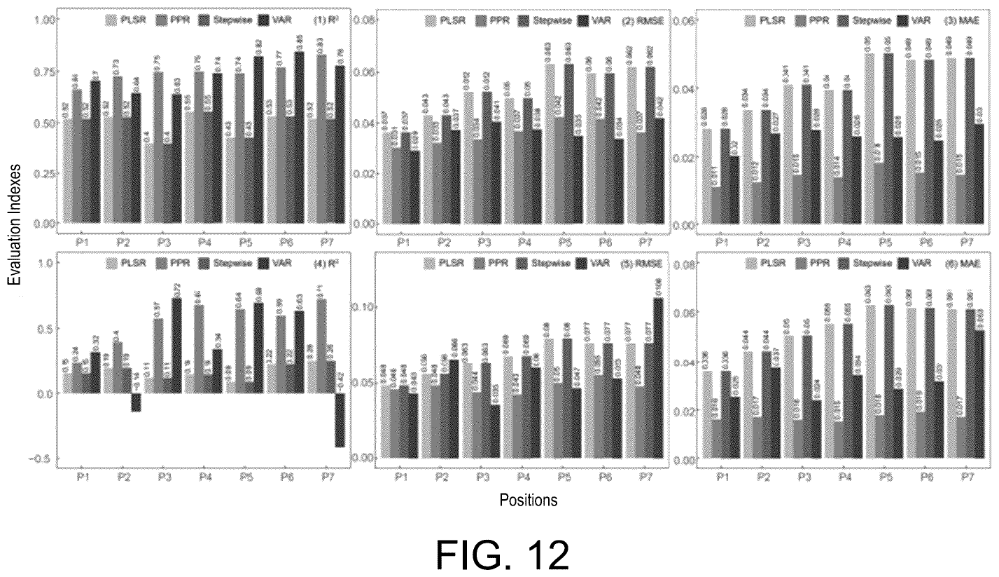

A time domain-based result evaluation is implemented starting from data of experimental results to obtain each precision index of the experimental results and the original time series. In the present disclosure, a coefficient of determination R², a root-mean-squares error (RMSE), and a mean absolute error (MAE) are computed, and results are shown in FIGS. 11 and 12. FIG. 11 shows the fitting results of the first 800 pieces of data, and FIG. 12 shows accuracy statistics of the fitting results of the first 800 pieces of data and the prediction results of the last 200 pieces of data. The first 3 subgraphs of each graph are generated by experiments using stepwise regression screening results, and the last 3 subgraphs are generated by experiments using RReliefF screening results.
5. Experimental verification

FIG. 5, FIG. 6, FIG. 7, and FIG. 8 shows the results of regression and prediction performed based on the results of two kinds of feature selection. In terms of the fitting results, the nonlinear relation-based projection pursuit regression and the time relation-based vector autoregression have better consistency with the original time series, but in terms of the prediction results, the linear relation-based prediction results are more stable. FIG. 9 and FIG. 10 are power spectrum density diagrams of the modeling and prediction results and the original time series, showing that the projection pursuit regression and the vector autoregression have a better degree of the fitting.

FIG. 11 and FIG. 12 show time domain-based evaluation indexes. In the evaluation of simulation prediction results, the larger the coefficient of determination R² is, the smaller the root-mean-square error and the mean absolute error are, which indicates that the correlation between the two sequences is greater. However, the root-mean-square error and the mean absolute error are related to the average level of the data itself, and thus the two errors cannot be used as evaluation indexes of the fitting accuracy between sites, but can compare the fitting accuracy differences of different modeling methods at a same site. As can be seen from FIG. 11, both the nonlinear relation-based projection pursuit regression and the time relation-based vector autoregression can obtain good fitting results, and the fitting accuracies of three methods based on linear regression are relatively low, where the accuracy of fitting results of features screened by using stepwise regression is higher than that of fitting results screened by using RReliefF. Since the number of features of RReliefF screening results is more than that of stepwise regression screening results, it can be shown that the results of screening using stepwise regression are more suitable for linear regression. The vector autoregression based on RReliefF screening results can achieve high accuracy in data fitting, but it is not good in sequence prediction, with a large error. In terms of RMSE and MAE, the projection pursuit regression and the vector autoregression show a significantly lower error in the first 800 pieces of fitting data than the linear regression, but vector autoregression shows prediction errors of some sites in the prediction of RReliefF screening results.

According to the multi-scale analysis method for time series based on quantum walk provided by the present disclosure, the time series are analyzed from the aspects of data generation, data screening, data modeling and prediction, and result evaluation, and a higher modeling or prediction accuracy may be obtained. Different methods used in the present disclosure have their own advantages. Both the nonlinear regression based on quantum walk feature sequences and the vector autoregression based on time can have a high accuracy in the fitting of the time series, but are not stable in the prediction of the time series; The linear regression based on quantum walk time series will lose some change details of the time series in the fitting of the time series, but is stable in the prediction of the time series.

1. A multi-scale analysis method for time series based on quantum walk, specifically comprising following steps:
step 1. for an original observed time series, generating a plurality of feature sequences at different time scales based on quantum walk;
step 2. performing feature selection on the plurality of feature sequences at different time scales generated in step 1 to obtain an optimal feature sequence combination;
step 3. establishing a correlation model of the original observed time series and the optimal feature sequence combination based on a regression analysis method; and
step 4. predicting an actual observed time series by using the correlation model in step 3, and prediction results are verified in the time domain and frequency domain.

2. The multi-scale analysis method for time series based on quantum walk according to claim 1, further comprising:
step 5. performing experimental verification on the multi-scale analysis method, wherein experimental configurations in the experimental verification are specifically as follows:
experiment data configuration: satellites in a plurality of Pacific positions are selected, and absolute sea level data obtained by height measurement of the satellites is periodically collected, and then processed to obtain experimental data; and
evaluation index configuration: a coefficient of determination R², a root-mean-square error (RMSE) and a mean absolute error (MAE) are selected as evaluation indexes of the prediction result of the model, wherein the evaluation indexes are specifically expressed as follows:
$${R}^{2} = 1 - \frac{{\sum }_{i = 1}^{N} {( {y}_{i} - {\hat{y}}_{i} )}^{2}}{{\sum }_{i = 1}^{N} {( {y}_{i} - \overline{y} )}^{2}} \\ RMSE = \sqrt{\frac{1}{N} {\sum }_{i = 1}^{N} {( {\hat{y}}_{i} - {y}_{i} )}^{2}} \\ MAE = \frac{1}{N} {\sum }_{i = 1}^{N} \vert {\hat{y}}_{i} - {y}_{i} \vert$$
wherein, yᵢ is an i-th element of the actual observed time series, ŷᵢ is an i-th element of a sequence obtained by prediction fitting, y̅ is an average value of elements of the actual observed time series, and N is the length of the time series.

3. The multi-scale analysis method for time series based on quantum walk according to claim 1, wherein step 1 is specifically implemented as follows:
representing a quantum walk process by an arbitrary undirected graph G=(V, E), wherein V is a set of vertices, and E is a set of edges; the vertices represent quantum states in the quantum walk process, and the edges represent transitions of the quantum states between the vertices;
representing a quantum state vector at an initial moment in the quantum walk process by |φ(0) [symbol] , and representing, utilizing a time evolution operator e^{-iHt}, a quantum state vector |φ(t) [symbol] at a moment t in the quantum walk process as:
$$\vert φ ( t ) 〉 = {e}^{- ith} \vert φ ( 0 ) 〉$$
wherein, | [symbol] is a symbol for labeling state vectors, e^{-iHt} is the time evolution operator, i is an imaginary unit, and H is a Hamiltonian represented by an adjacency matrix or a Laplacian matrix;
decomposing a spectrum of the Hamiltonian H by using a spectrum decomposition algorithm to obtain eigenvalues and eigenvectors of the Hamiltonian H, wherein the decomposed Hamiltonian His:
$$H = {ΦΛΦ}^{T}$$
wherein, Φ is an N×N matrix, which represents a set of the eigenvectors; T represents a transposition; Λ is an N×N diagonal matrix, which is specifically expressed as Λ=diag (λ₁, λ₂, . . . , λₙ, . . . , λ_{N}), λ₁, λ₂, . . . , λ_{N} are the ordered eigenvalues of the Hamiltonian H; and N is the length of the time series;
the time evolution operator is expressed as e−^{iHt}=Φe^{-iΛt}Φ^{T}, and then
the quantum state vector |φ(t) [symbol] at the moment t in the quantum walk process is expressed as:
$$\vert φ ( t ) 〉 = Φ {e}^{- i Λ t} {Φ}^{T} \vert φ ( 0 ) 〉 ;$$
constructing a scale factor set {kⱼ}ⱼ₌₁^{J}, wherein J represents the total number of scale factors, and kⱼ represents a j-th scale factor; and when the moment t is replaced with kⱼn, the quantum state vector in the quantum walk process is expressed as:
$$\vert φ ( {k}_{j} n ) 〉 = Φ {e}^{- j Λ {k}_{j} n} {Φ}^{T} \vert φ ( 0 ) 〉 , {k}_{j} ∈ {ℝ}^{+}$$
wherein, [symbol] ⁺ represents a positive real number, n is a natural number, n=0, 1, 2, . . . ; and
sampling the quantum walk process at an equal time interval based on the scale factor kⱼ to obtain a sequence of norm squares of probability amplitudes corresponding to all the vertices, thereby generating the feature sequences of the quantum walk at different time scales.

4. The multi-scale analysis method for time series based on quantum walk according to claim 3, wherein the Hamiltonian H is represented by an adjacency matrix of graph G, and elements in the adjacency matrix of the graph G is expressed as:
$${A}_{uv} = \{ \begin{matrix}1 , & if ( u , v ) ∈ E \\ 0 , & otherwise\end{matrix}$$
wherein, (u, v) represents an edge connecting a vertex u to a vertex v, Aᵤᵥ represents an edge between the vertex u and the vertex v, u∈V, v∈V, and Aᵤᵥ=Aᵥᵤ, and Aᵥᵥ=Aᵤᵤ=0.

5. The multi-scale analysis method for time series based on quantum walk according to claim 1, wherein in step 2, feature selection is performed on the generated plurality of feature sequences at different time scales by using stepwise regression, which is implemented as follows:
combining the feature sequences at different time scales, constantly adjusting the combinations, evaluating the fitting accuracy in using the combinations to model the original observed time series by using the Akaike information criterion, and selecting a combination with the best evaluation result as the optimal feature sequence combination;
alternatively,
feature selection is performed on the generated plurality of feature sequences at different time scales by using the RReliefF algorithm, which is implemented as follows:
performing weight computation on the plurality of feature sequences at different time scales in step 1 based on the original observed time series, performing sorting according to the weights from large to small, and combining the first Q feature sequences at different time scales to form the optimal feature sequence combination.

6. The multi-scale analysis method for time series based on quantum walk according to claim 1, wherein the regression analysis method in step 3 comprises linear regression, nonlinear regression, or time-correlation-based vector autoregression methods, wherein the linear regression comprises but is not limited to stepwise regression, principal component regression, and partial least squares regression; and the nonlinear regression comprises but is not limited to projection pursuit regression.

7. The multi-scale analysis method for time series based on quantum walk according to claim 6, wherein in step 3, a correlation model of the original observed time series and the optimal feature sequence combination is established based on the linear regression, which is specified as follows:
$$Y = {β}_{1} {X}_{1} + {β}_{2} {X}_{2} + … + {β}_{q} {X}_{q} + ε$$
wherein, Y is a fitted time series, X₁, X₂, . . . , X_{q} are sequences in the optimal feature sequence combination respectively, β₁, β₂, . . . , β_{q} are coefficients of the sequences respectively, and ε is a constant term.

8. The multi-scale analysis method for time series based on quantum walk according to claim 6, wherein in step 3, a correlation model of the original observed time series and the optimal feature sequence combination is established based on the projection pursuit regression, which is specified as follows:
$$F ( x ) \sim {\sum }_{m = 1}^{M} {β}_{m} {G}_{m} ( {Z}_{m} ) = {\sum }_{m = 1}^{M} {β}_{m} {G}_{m} ( {\sum }_{p = 1}^{P} {a}_{mp}^{T} X )$$
wherein, F(x) represents a fitted time series, Gₘ(Zₘ) represents a m-th ridge function, βₘ is a weight and represents the contribution of the m-th ridge function to an output value, M represents the total number of the ridge functions,
$${Z}_{m} = {\sum }_{p = 1}^{P} {a}_{mp}^{T} X$$
is an independent variable of the m-th ridge function and represents a projection of a P-dimensional vector X in an αₘ direction, X represents high-dimensional data input in the model, αₘₚ is a p-th component of the projection in the αₘ direction, a superscript T represents a transposition, P is a dimension of input space,
$${\sum }_{p = 1}^{P} {a}_{p}^{2} = 1$$
is required, and αₚ represents a p-th component in a projection direction.

9. The multi-scale analysis method for time series based on quantum walk according to claim 6, wherein in step 3, a correlation model of the original observed time series and the optimal feature sequence combination is established based on the time-correlation-based vector autoregression, and the sequences in the optimal feature sequence combination are expressed in the form of a matrix as Y={X₁, X₂, . . . X_{w}, . . . , X_{L}}∈ [symbol] ^{N×L}, w∈[1, L], which is implemented specifically as follows:
$${X}_{w} = {( {X}_{1 w} , {X}_{2 w} , … , {X}_{Nw} )}^{T} ∈ {ℝ}^{N \times 1} \\ {X}_{w} = {\sum }_{z = 1}^{d} {A}_{z} {X}_{w - z} + {ε}_{w} , w = d + 1 , … , L$$
wherein, N represents the length of the time series, L represents the number of the sequences in the optimal feature sequence combination, X_{w} represents vectors in a w-th column of a matrix Y, X_{w-z} represents vectors in a w-z-th column of the matrix Y, X_{Nw} represents an element value in the N-th row and the w-th column of the matrix Y, A_{z}∈ [symbol] ^{N×N} is a coefficient matrix of the time-correlation-based vector autoregression, z is a lag order, d is a total lag order, and ε_{w} represents noise.

10. The multi-scale analysis method for time series based on quantum walk according to claim 1, wherein in step 4, time-frequency domain-based result evaluation is performed on a prediction result, which is implemented specifically as follows:
selecting a coefficient of determination R², a root-mean-square error (RMSE), and a mean absolute error (MAE) as evaluation indexes of the prediction result of the model, wherein the evaluation indexes are expressed as follows:
$${R}^{2} = 1 - \frac{{\sum }_{i = 1}^{N} {( {y}_{i} - {\hat{y}}_{i} )}^{2}}{{\sum }_{i = 1}^{N} {( {y}_{i} - \overline{y} )}^{2}} \\ RMSE = \sqrt{\frac{1}{N} {\sum }_{i = 1}^{N} {( {\hat{y}}_{i} - {y}_{i} )}^{2}} \\ MAE = \frac{1}{N} {\sum }_{i = 1}^{N} \vert {\hat{y}}_{i} - {y}_{i} \vert$$
wherein, yᵢ is an i-th element of the actual observed time series, ŷᵢ is an i-th element of a fitted sequence obtained by prediction, y̅ is an average value of elements of the actual observed time series, and N is the length of the time series.
